(19) United States
(12) Patent Application Publication
(10) Pub. No.: US 2022/0393339 A1
(43) Pub. Date: Dec. 8, 2022

(54) BASE STATION ANTENNAS HAVING ALUMINUM ALLOY COATED MILD STEEL REFLECTOR ASSEMBLIES

(71) Applicant: CommScope Technologies LLC, Hickory, NC (US)

(72) Inventor: Brijesh Kumar Soni, Bainguinim (IN)

(21) Appl. No.: 17/737,105

(22) Filed: May 5, 2022

(30) Foreign Application Priority Data
May 6, 2021 (IN) 202121020680

(51) Int. Cl. H01Q 1/24; H01Q 15/14; H01Q 1/42; H01Q 21/26

(52) U.S. Cl. CPC H01Q 1/246; H01Q 15/14; H01Q 1/42; H01Q 21/26

(57) ABSTRACT

A reflector assembly configured to be disposed within a radome of the base station antenna. A reflector of the reflector assembly is composed of an aluminum alloy coated mild steel. Further, the reflector may include lateral sides extending along a longitudinal axis of the reflector, and each lateral side may be bent to form a U-shaped profile. Also, the reflector assembly comprises one or more support members and one or more mounting brackets that are adapted to provide support and facilitate mounting of the reflector in the radome. The one or more support members and the one or more mounting brackets may be composed of an aluminum alloy coated mild steel.

### CROSS-REFERENCE TO RELATED APPLICATION

The present application claims priority to Indian Provisional Patent Application No. 202121020680, filed May 6, 2021, the entire content of which is incorporated herein by reference as if set forth in its entirety.

### TECHNICAL FIELD

The present disclosure generally relates to the field of radio communication and, more particularly, to reflector assemblies for base station antennas for cellular communications systems and to base station antennas that include such reflector assemblies.

### BACKGROUND

The information in this section merely provides background information related to the present disclosure and may not constitute prior art for the present disclosure.

Cellular communications systems are used to provide wireless communications to fixed and mobile subscribers (herein “users”). A cellular communications system may include a plurality of base stations that each provide wireless cellular service for a specified coverage area that is typically referred to as a “cell.” Each base station may include one or more base station antennas that are used to transmit radio frequency (“RF”) signals to, and receive RF signals from, the users that are within the cell served by the base station. Base station antennas are directional devices that can concentrate the RF energy that is transmitted in certain directions (or received from those directions). The “gain” of a base station antenna in a given direction is a measure of the ability of the antenna to concentrate the RF energy in that particular direction. The “radiation pattern” of a base station antenna is compilation of the gain of the antenna across all different directions. The radiation pattern of a base station antenna is typically designed to service a pre-defined coverage area such as the cell or a portion thereof that is typically referred to as a “sector.” The base station antenna may be designed to have maximum gain levels throughout its pre-defined coverage area, and it is typically desirable that the base station antenna have much lower gain levels outside of the coverage area to reduce interference between sectors/cells. Typically, the base station antennas are mounted on a tower or other raised structure, with the radiation patterns that are generated by the base station antennas directed outwardly.

Most base station antennas comprise one or more linear or planar arrays of radiating elements that are mounted on a reflector assembly that includes a flat panel. The reflector assembly may serve as a ground plane for the radiating elements and may also reflect RF energy that is emitted rearwardly by the radiating elements back in the forward direction. FIGS. 1A and 1B are a perspective view and a cross-sectional view, respectively, of a conventional reflector assembly 10 for a base station antenna. The reflector assembly 10 has a reflector having a front 12, a back 14 and first and second sides 16. Conventionally, the reflector is made from aluminum, and the front 12 thereof may serve as a main reflective surface 20 that reflects RF energy. One or more of the top, bottom and side edges of the reflector may be bent backwardly at an angle, such as a 90° angle. Accordingly, each side 16 of the reflector may have an L-shaped cross-section, as shown in FIG. 1B. A plurality of openings 22 may be provided in the main reflective surface 20. For example, openings 22 may be provided at the locations where each radiating element of the base station will be mounted to allow rearwardly protruding feed stalks of such radiating elements to extend into the openings. Openings 22 may also be provided for coaxial cables that electrically connect the radiating elements to feed networks that are partially implemented behind the reflector assembly. Additional openings 22 may be provided that are used to mount various components of the base station antenna (e.g., via screws, rivets or other attachment structures) to the reflector assembly 10 such as, for example, radiating elements, feed boards, decoupling structures, isolation structures and/or structural supports.

### SUMMARY

The one or more shortcomings of the prior art are overcome by the system/assembly as claimed, and additional advantages are provided through the provision of the system/assembly/method as claimed in the present disclosure. Additional features and advantages are realized through the techniques of the present disclosure. Other embodiments and aspects of the disclosure are described in detail herein and are considered a part of the claimed disclosure.

In accordance with an aspect of the present disclosure, a reflector assembly for a base station antenna is disclosed. The reflector assembly is configured to be disposed within a radome of the base station antenna. The reflector assembly comprises a reflector configured to mount a plurality of radiating elements thereon. Further, the reflector of the reflector assembly is composed of an aluminum alloy coated mild steel.

In another non-limiting embodiment of the present disclosure, the reflector comprises lateral sides extending along a longitudinal axis of the reflector, and each lateral side is bent to form a U-shaped profile, when viewed from a side of the reflector.

In another non-limiting embodiment of the present disclosure, a free end of the U-shaped profile of each lateral side is bent outwardly away from the reflector.

In another non-limiting embodiment of the present disclosure, a free end of the U-shaped profile of each lateral side is bent inwardly towards the reflector.

In another non-limiting embodiment of the present disclosure, the reflector comprises two portions arranged at an angle with respect to each other to form an ‘inverted V-shape’. Further, each of the two portions is inclined at an angle of around 27 degrees from a plane containing a line of contact of the two portions.

In another non-limiting embodiment of the present disclosure, the reflector assembly comprises one or more support members and one or more mounting brackets that are adapted to provide support and facilitate mounting of the reflector in the radome. The one or more support members and the one or more mounting brackets are composed of an aluminum alloy coated mild steel.

In another non-limiting embodiment of the present disclosure, the aluminum alloy coated mild steel comprises a steel base coated with an aluminum alloy by a hot dipping process.

In another non-limiting embodiment of the present disclosure, the reflector comprises a steel substrate having an electromagnetic reflective surface made of an aluminum alloy coating. In non-limiting embodiments the alluminum alloy coated mild steel may be either an aluminum silicon coated mild steel or an aluminum zinc coated mild steel.

In accordance with another aspect of the present disclosure, a base station antenna is disclosed. The base station antenna comprises a radome, a top cap and a bottom cap to cover openings of the radome, and a reflector assembly configured to be disposed within the radome. The reflector assembly comprises a reflector configured to mount a plurality of radiating elements thereon. Further, the reflector of the reflector assembly is composed of an aluminum alloy coated mild steel.

In another non-limiting embodiment of the present disclosure, the reflector comprises lateral sides extending along a longitudinal axis of the reflector, and each lateral side is bent to form a U-shaped profile, when viewed from a side of the reflector.

In another non-limiting embodiment of the present disclosure, a free end of the U-shaped profile of each lateral side is bent outwardly away from the reflector.

In another non-limiting embodiment of the present disclosure, a free end of the U-shaped profile of each lateral side is bent inwardly towards the reflector.

In another non-limiting embodiment of the present disclosure, the reflector comprises two portions arranged at an angle with respect to each other to form an ‘inverted V-shape’. Each of the two portions is inclined at an angle of around 27 degrees from a plane containing a line of contact of the two portions.

In another non-limiting embodiment of the present disclosure, the reflector assembly of the base station antenna comprises one or more support members and one or more mounting brackets that are adapted to provide support and facilitate mounting of the reflector in the radome. The one or more support members and the one or more mounting brackets are composed of an aluminum alloy coated mild steel.

In another non-limiting embodiment of the present disclosure, the aluminum alloy coated mild steel may comprise a steel base coated with either an aluminum silicon alloy or an aluminum zinc alloy by a hot dipping process.

In another non-limiting embodiment of the present disclosure, the reflector comprises a steel substrate having an electromagnetic reflective surface made of an aluminum alloy coating (e.g., an aluminum silicon or an aluminum zinc coating).

In accordance with yet another aspect of the present disclosure, a method of manufacturing a reflector assembly for a base station antenna is disclosed. The reflector assembly is configured to be disposed within a radome of the base station antenna. The method comprises providing a reflector configured for mounting a plurality of radiating elements thereon, wherein the reflector of the reflector assembly is composed of an aluminum alloy coated mild steel formed by coating a steel base with an aluminum alloy by a hot dipping process.

In another non-limiting embodiment of the present disclosure, the method comprises bending lateral sides of the reflector to form a U-shaped profile, when viewed from a side of the reflector, the lateral sides of the reflector extending along a longitudinal axis of the reflector.

In another non-limiting embodiment of the present disclosure, the method further comprises at least one of grinding or buffing the reflector to achieve a surface finish of the reflector.

It is to be understood that the aspects and embodiments of the disclosure described above may be used in any combination with each other. Several of the aspects and embodiments may be combined together to form a further embodiment of the disclosure.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF FIGURES

The novel features and characteristics of the disclosure are set forth in the description. The disclosure itself, however, as well as a preferred mode of use, further objectives, and advantages thereof, will best be understood by reference to the following description of an illustrative embodiment when read in conjunction with the accompanying drawings. One or more embodiments are now described, by way of example only, with reference to the accompanying drawings wherein like reference numerals represent like elements and in which:

FIG. 1A is a perspective view of a conventional reflector assembly for a base station antenna.

FIG. 1B is a side cross-sectional view taken along line 1B-1B of the reflector assembly of FIG. 1A.

FIG. 2 is a perspective view of a base station antenna, in accordance with an embodiment of the present disclosure.

FIG. 3 is a bottom perspective view of a mounting bracket of the base station antenna of FIG. 2, in accordance with an embodiment of the present disclosure.

FIG. 4 is a side cross-sectional view of a reflector assembly of the base station antenna of FIG. 2 taken along the line 6-6 of FIG. 2, according to an embodiment of the present disclosure.

FIG. 5 is a side view of a reflector assembly of the base station antenna of FIG. 2, in accordance with a first embodiment of the present disclosure.

FIG. 6 depicts a perspective view of a support member of the reflector assembly of FIG. 5, in accordance with an embodiment of the present disclosure.

FIG. 7 is a side view of a reflector assembly of the base station antenna of FIG. 2, in accordance with a second embodiment of the present disclosure.

FIG. 8 is a side view of a reflector assembly of the base station antenna of FIG. 2, in accordance with a third embodiment of the present disclosure.

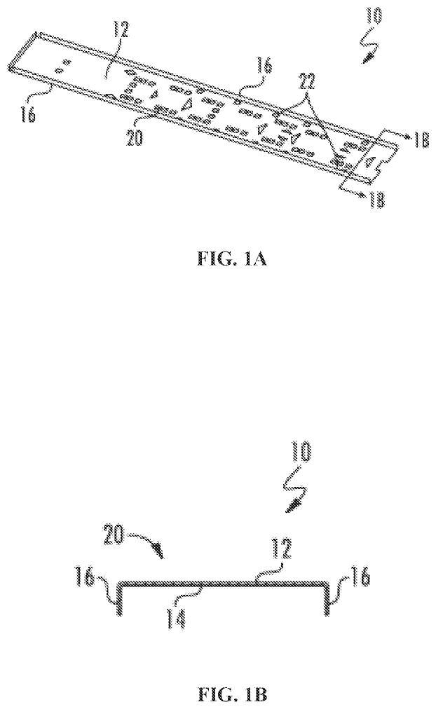

Skilled artisans will appreciate that elements in the drawings are illustrated for simplicity and have not necessarily been drawn to scale. For example, the dimensions of some of the elements in the drawings may be exaggerated relative to other elements to help to improve understanding of embodiments of the present disclosure.

### DETAILED DESCRIPTION

While the disclosure is susceptible to various modifications and alternative forms, specific embodiments thereof are shown by way of example in the FIGS. and will be described in detail below. It should be understood, however that it is not intended to limit the disclosure to the particular forms disclosed, but on the contrary, the disclosure is to cover all modifications, equivalents, and alternatives falling within the scope of the disclosure as defined by the appended claims.

The present application discloses improved reflector assemblies for base station antennas, and to base station antennas that include such reflector assemblies and to methods for manufacturing such reflector assemblies and base station antennas. It is to be noted that a person skilled in the art can be motivated from the present disclosure and modify the disclosed of the reflector assemblies and base station antennas. However, such modification should be construed within the scope of the present disclosure. Accordingly, the drawings are showing only those specific details that are pertinent to understanding the embodiments of the present disclosure so as not to obscure the disclosure with details that will be readily apparent to those of ordinary skill in the art having benefit of the description herein.

In the present disclosure, the term “exemplary” is used herein to mean “serving as an example, instance, or illustration.” Any embodiment or implementation of the present subject matter described herein as “exemplary” is not necessarily to be construed as preferred or advantageous over other embodiments.

The terms “comprises”, “comprising”, or any other variations thereof, are intended to cover a non-exclusive inclusions, such that a device that comprises a list of components does not include only those components but may include other components not expressly listed or inherent to such setup or device. In other words, one or more elements in a system or apparatus proceeded by “comprises . . . a” does not, without more constraints, preclude the existence of other elements or additional elements in the system or apparatus.

Terms like “at least one,” “plurality” and “one or more” may be used interchangeably or in combination throughout the description.

According to first aspect of the present disclosure, a reflector assembly for a base station antenna is disclosed. The reflector assembly is configured to be disposed within a radome of the base station antenna. The reflector assembly comprises a reflector configured to mount a plurality of radiating elements thereon. At least the reflector of the reflector assembly is composed of an aluminum alloy coated mild steel. An aluminum alloy coated mild steel refers to a material having a steel base that is coated with an aluminum alloy by, for example, a hot dipping process. In example embodiments, the aluminum alloy may be aluminum silicon or aluminum zinc. Thus, the reflector may comprise a steel substrate having an electromagnetic reflective surface made of an aluminum silicon or aluminum zinc coating

The reflector comprises lateral sides extending along a longitudinal axis of the reflector. In some embodiments, each lateral side may be bent to form a U-shaped profile, when viewed from the top or bottom of the reflector. In an embodiment, a free end of the U-shaped profile of each lateral side is bent outwardly away from the reflector. In alternate embodiment, a free end of the U-shaped profile of each lateral side is bent inwardly towards the reflector. In a further embodiment, the reflector comprises two portions arranged at an angle with respect to each other to form an inverted V-shape, and each of the two portions is inclined at an angle of around 25-33° from a plane containing a line of contact of the two portions.

In a further embodiment, the reflector assembly comprises one or more support members and one or more mounting brackets that are adapted to provide support and facilitate mounting of the reflector in the radome. The one or more support members and the one or more mounting brackets are composed of an aluminum alloy coated mild steel. In example embodiments, the aluminium alloy coated mild steel may be aluminium silicon coated mild steel or aluminium zinc coated mild steel.

According to second aspect of the present disclosure, a base station antenna is disclosed. The base station antenna comprises a radome, a top cap and a bottom cap to cover respective top and bottom openings of the radome, and a reflector assembly that is configured to be disposed within the radome. The reflector assembly comprises a reflector configured to mount a plurality of radiating elements thereon. At least the reflector of the reflector assembly is composed of an aluminum alloy coated mild steel. The aluminium alloy coated mild steel may be, for example, an aluminium silicon coated mild steel or an aluminium zinc coated mild steel.

The reflector comprises lateral sides extending along a longitudinal axis of the reflector, and each lateral side is bent to form a U-shaped profile, when viewed from a top or bottom of the reflector. In an embodiment, a free end of the U-shaped profile of each lateral side is bent outwardly away from the reflector. In alternate embodiment, a free end of the U-shaped profile of each lateral side is bent inwardly towards the reflector. In a further embodiment, the reflector comprises two portions arranged at an angle with respect to each other to form an inverted V-shape. Each of the two portions is inclined at an angle of around 25-33° from a plane containing a line of contact of the two portions.

In an embodiment, the reflector assembly of the base station antenna comprises one or more support members and one or more mounting brackets that are adapted to provide support and facilitate mounting of the reflector in the radome. The one or more support members and the one or more mounting brackets are composed of an aluminum alloy coated mild steel. The aluminium alloy coated mild steel may be, for example, an aluminium silicon coated mild steel or an aluminium zinc coated mild steel.

According to third aspect of the present disclosure, a method of manufacturing a reflector assembly for a base station antenna is disclosed. The reflector assembly is configured to be disposed within a radome of the base station antenna. The method comprises providing a reflector configured for mounting a plurality of radiating elements thereon, wherein the reflector of the reflector assembly is composed of an aluminum alloy coated mild steel formed by coating a steel base with an aluminum alloy by a hot dipping process. The aluminium alloy coated mild steel may be, for example, an aluminium silicon coated mild steel or an aluminium zinc coated mild steel. In an embodiment, the method comprises bending lateral sides of the reflector to form a U-shaped profile, when viewed from a side of the reflector, the lateral sides of the reflector extending along a longitudinal axis of the reflector. In an embodiment, the method comprises at least one of grinding or buffing the reflector to achieve a surface finish of the reflector.

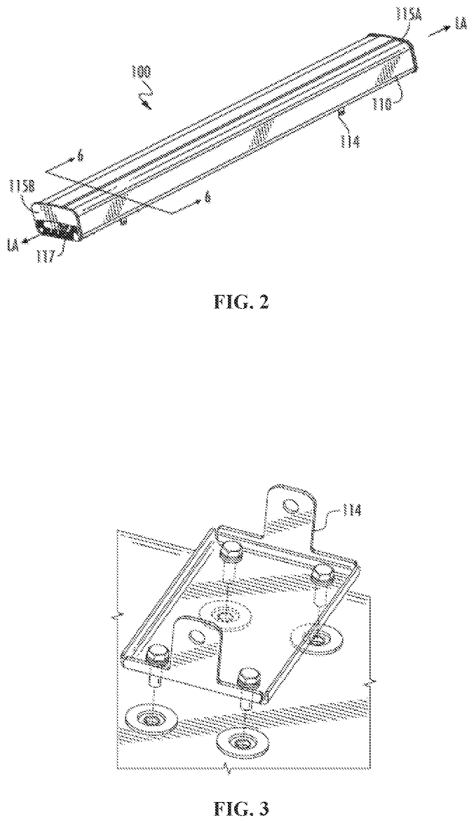

Reference will now be made to the exemplary embodiments of the disclosure, as illustrated in the accompanying drawings. Wherever possible, same numerals will be used to refer to the same or like parts. Embodiments of the disclosure are described in the following paragraphs with reference to FIGS. 2 to 8. In FIGS. 2 to 8, the same element or elements which have same functions are indicated by the same reference signs.

Referring to FIG. 2, a base station antenna 100 according to an embodiment of the present disclosure is illustrated. Within the scope of the present disclosure, the base station antenna 100 and the components thereof are described using terms that assume that the base station antenna 100 is mounted for use on a tower with a longitudinal axis LA-LA of the base station antenna 100 extending along a vertical (or near vertical) axis and a front surface of the base station antenna 100 is mounted opposite the tower pointing toward the coverage area for the base station antenna 100. As shown in FIG. 2, the base station antenna 100 is an elongated structure and may have a generally rectangular shape. The base station antenna 100 comprises a radome 110, a top end cap 115A, and a bottom end cap 115B. The radome 110 defines an internal cavity that receives a reflector assembly 210. The bottom end cap 115B may cover a bottom opening of the radome 110. In a non-limiting embodiment, the radome 110 may be made of fiberglass. In some embodiments, the top end cap 115A and the radome 110 may be manufactured as a single integral unit, for waterproofing the base station antenna 100. As shown in FIGS. 2 and 3, one or more mounting brackets 114 are provided on a back side of the base station antenna 100 for mounting the base station antenna 100 onto a structure, such as, but not limited to, an antenna tower. The bottom end cap 115B may include a plurality of connectors 117 mounted therein that receive cables that carry RF signals between the base station antenna 100 and one or more associated radios. The base station antenna 100 is typically mounted in a vertical configuration (i.e., the long side of the base station antenna 100 extends along a vertical axis with respect to the horizon). In an embodiment, the base station antenna 100 comprises a dipole made from an aluminum alloy coated mild-steel.

Without deviating from the scope of the present disclosure, the base station antenna 100 may comprises, among other things, RF ports, a multi-column array of radiating elements, and phase shifters. The multi-column array may comprise columns that each include plurality of dual-polarized radiating elements. Further, the radiating elements may be cross-polarized radiating elements, such as, +45°/−45° slant dipole radiating elements, that may transmit and receive RF signals at two orthogonal polarizations. Any other appropriate radiating element may also be used including, for example, single dipole radiating elements or patch radiating elements (including cross-polarized patch radiating elements). When cross-polarized radiating elements are used, two feed networks may be provided per column, a first of which carries RF signals having the first polarization (e.g., +45°) between the radiating elements and a first RF port and the second of which carries RF signals having the second polarization (e.g., −45°) between the radiating elements and a second RF port. Without limiting the present disclosure, the RF ports may be included in the bottom end cap 115B of the base station antenna 100.

An input of each phase shifter may be connected to a respective one of the RF ports. Each RF port may be connected to a corresponding port of a radio (not shown), such as, for example, a beamforming radio or a remote radio head, that may be part of the base station antenna 100 or mounted adjacent the base station antenna 100. Each phase shifter has outputs that may be, for example, directly connected to respective subsets of the radiating elements of an array or connected to respective feed boards comprising a printed circuit board that each have one or more radiating elements mounted thereon. Each phase shifter may divide an RF signal that is input thereto into sub-components and may impart a phase taper to the sub-components of the RF signal that are provided, for example, to each feed board. Each feed board may further include power dividers (one for each polarization), and the sub-components of the RF signals that are input to the feed boards may be split by the power dividers and fed to the respective radiating elements.

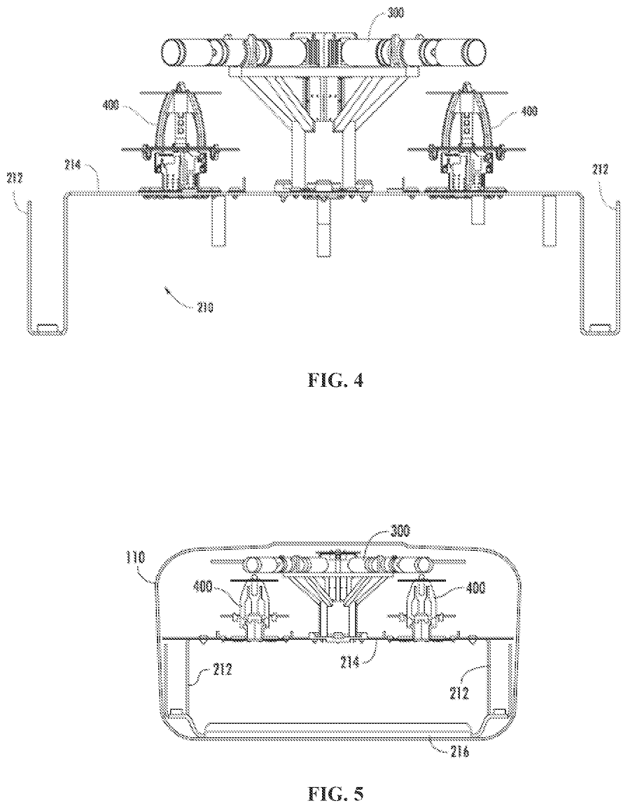

In accordance with the present disclosure, referring to FIG. 4, a reflector assembly 210 for the base station antenna 100 is disclosed. The reflector assembly 210 is configured to be disposed within the radome 110 of the base station antenna 100. In an embodiment, the reflector assembly 210 may be slidably inserted into the radome 110 through the bottom opening thereof. The reflector assembly 210 comprises a reflector 214 and a plurality of radiating elements 300, 400. A plurality of radiating elements 300, 400 may be mounted to extend forwardly from the reflector. The plurality of radiating elements may comprise, for example, a plurality of low-band radiating elements 300 that are configured to operate in all or part of the 617-960 MHz frequency range, a plurality of mid-band radiating elements 400 that are configured to operate in all or part of the 1427-2690 MHz frequency range, and/or a plurality of high-band radiating elements (not shown) that are configured to operate in all or part of the 3.1-5.8 GHz frequency range.

In accordance with the present disclosure, at least the reflector 214 of the reflector assembly 210 is composed of an aluminum alloy coated mild steel. Within the scope of the present disclosure, an aluminum alloy coated mild steel comprises a steel base that is coated with an aluminum alloy by, for example, a hot dipping process. Forming the aluminum alloy coated mild steel using a hot dipping process assures a tight metallurgical bond between the steel and the aluminum alloy coating, and produces a material with a combination of properties neither possessed by steel nor by aluminum. Said properties of the aluminum alloy coated mild steel include, but are not limited to, high heat resistance (e.g., up to 600° C.), high heat reflectivity (e.g., up to 450° C.), high corrosion resistance (due to the coating characteristics to form a thin stable oxide layer and hydroxidation layer in air and water, respectively), improved salt spray life (aluminum shows lowered electrochemical potential in saline water), high reflectivity, etc. In an embodiment, the reflector 214 comprises a steel substrate having an electromagnetic reflective surface made of an aluminum alloy coating. The aluminium alloy coated mild steel may be, for example, an aluminium silicon coated mild steel or an aluminium zinc coated mild steel.

As illustrated in FIGS. 4 and 5, the reflector 214 comprises lateral sides extending along a longitudinal axis LA-LA of the reflector 214. The longitudinal axis LA-LA of the reflector 214 may extend parallel to or colinear to the longitudinal axis LA-LA of the base station antenna 100. Each lateral side of the reflector assembly 210 may be bent to form a U-shaped profile 212, when viewed from a top or bottom of the reflector 214, as shown in FIGS. 4 and 5. In some embodiments, a free end of the U-shaped profile 212 of each lateral side may be bent outwardly away from the reflector 214 of the reflector assembly 210. In other embodiments, the free end of the U-shaped profile 212 of each lateral side may be bent inwardly towards the reflector 214 of the reflector assembly 210 (see FIG. 7). As illustrated in FIGS. 4 and 5, the free end of the U-shaped profile 212 of each lateral side extends laterally away from the reflector 214. In accordance with the present disclosure, the U-shaped profile 212 forms an RF choke on each side of the reflector 214 that facilitates reducing an amount of RF energy that is emitted backwardly from the base station antenna 100 by currents that pass from the front surface of the reflector 214 to the back surface of the reflector 214.

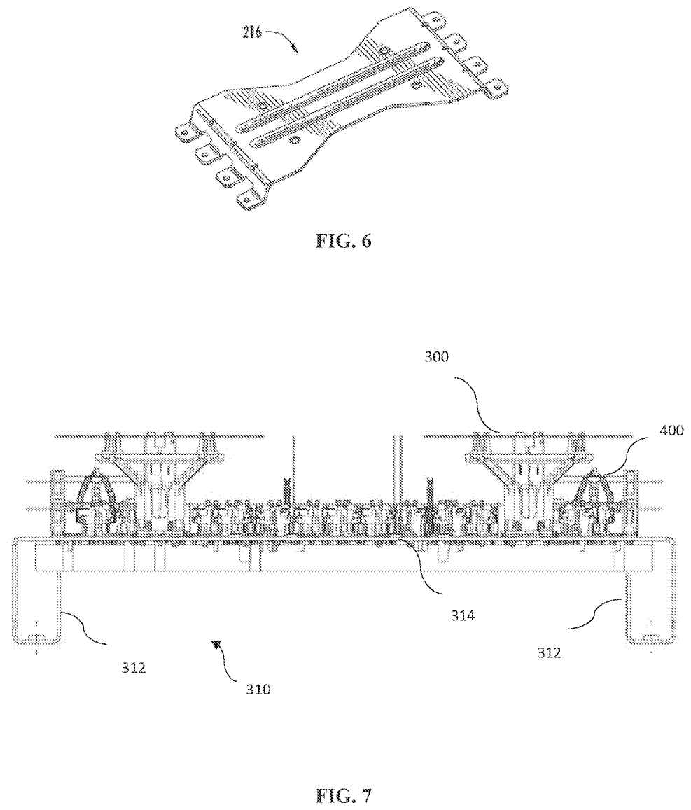

Further, the reflector 214 may be connected along its backside with one or more support members 216, as shown in FIGS. 5 and 6, that provide additional support to the reflector assembly 210. In an embodiment, each mounting bracket 114 (as shown in FIGS. 2 and 3), may be attached to a respective support member 216. Typically, there may be three to six support members 216 attached along the length of the reflector 214 in spaced apart manner to provide structural support to the reflector assembly 210. In an aspect of the present disclosure, the reflector assembly 210 including the reflector 214, the one or more support members 216, and the one or more mounting brackets 114 are made from an aluminum alloy coated mild steel. The aluminum alloy coated mild steel comprises a steel base coated on both sides with an aluminum alloy by a hot dipping process. Alternatively, the aluminum alloy may be painted or sprayed onto the steel base. The aluminium alloy coated mild steel may be, for example, an aluminium silicon coated mild steel or an aluminium zinc coated mild steel.

FIG. 7 depicts a side view of a reflector assembly 310, according to another embodiment of the present disclosure. The reflector assembly 310 comprises a reflector 314. A plurality of radiating elements 300, 400 are mounted to extend forwardly from a front side of the reflector 314. Each lateral side of the reflector 314 has a U-shaped profile 312 extending laterally inwards towards the reflector 314. The U-shaped profile 312 of the reflector assembly forms an RF choke on each side of the reflector 314 that facilitates reducing the amount of RF energy that is emitted backwardly from the base station antenna 100 by currents that pass from the front surface of the reflector 314 to the back surface of the reflector 314.

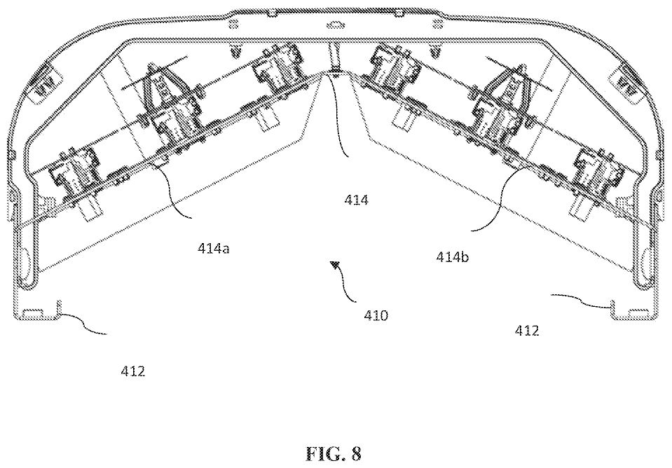

FIG. 8 depicts a side view of a reflector assembly 410 according to yet another embodiment of the present disclosure. The reflector assembly 410 comprises a reflector 414. The reflector 414 comprises two portions 414a, 414b that are arranged at an angle with respect to each other to form an inverted V-shape of the reflector 414. In an embodiment of the present disclosure, each of the two portions 414a, 414b is inclined at an angle of around 25-33° from a plane (not shown) containing a line of contact of the two portions 414a, 414b. Also, each lateral side of the reflector 414 has a U-shaped profile 412 extending laterally inwards towards the reflector 414. The U-shaped profile 412 forms an RF choke on each side of the reflector 414 that facilitates reducing an amount of RF energy that is emitted backwardly from the base station antenna 100 by currents that pass from the front surface of the reflector 414 to the back surface of the reflector 414.

In an aspect of the present disclosure, the reflector assemblies 310, 410, as shown in FIGS. 7 and 8, respectively, are made from an aluminum alloy coated mild steel. The aluminum alloy coated mild steel may comprise, for example, a steel base coated on both sides with an aluminum alloy such as aluminum silicon or aluminum zinc by a hot dipping process. Using a hot dipping process to coat the aluminum alloy on the steel base assures a tight metallurgical bond between the steel and the aluminum alloy coating, and thus producing a material with a combination of properties neither possessed by steel nor by aluminum. The properties of the aluminum alloy coated mild steel may includes, but are not limited to, high heat resistance—upto 600° C., high heat reflectivity—up to 450° C., high corrosion resistance—due to the coating characteristics to form a thin stable oxide layer and hydroxidation layer in air and water, respectively, improved salt spray life—aluminum shows lowered electrochemical potential in saline water, high reflectivity, etc. In other embodiments, the aluminum alloy may be painted or sprayed onto the steel base.

Further, in an embodiment, the reflectors 214, 314, 414 may comprise a substrate and an electromagnetically reflective surface. The substrate may comprise a steel substrate having an electromagnetic reflective surface comprising an aluminum alloy coating. In some embodiments, a thickness of the reflector 214, 314, 414 may vary between 0.2 mm to 2.4 mm. In further embodiments, the thickness of the reflectors 214, 314, 414 may vary between 0.6 mm and 1.2 mm. Further, the reflectors 214, 314, 414 may comprise mounting holes or openings defined therein and extending through the substrate and the electromagnetic reflective surface. The reflectors 214, 314, 414 may comprise, for example, a stamped or cut steel sheet that is then subjected to a bending process to have the shape of the reflector as shown in FIGS. 4, 7, 8 or any other appropriate shape offering the results and technical effects/advancement of the present disclosure.

In a non-limiting embodiment of the present disclosure, a multi-step bending process may be employed to achieve a desired shape of the reflectors. For example, the reflectors 214, 314, 414 may be manufactured through multiple smaller bends, such as two 45° bends, at the same location. In order to improve the passive intermodulation distortion (PIM) performance of the reflectors 214, 314, 414, surface treatment/finishing techniques, such as grinding and/or buffing may be employed. In use, the electromagnetic reflective surface serves to reflect RF energy from the radiating elements 300, 400 in a forward direction. In an embodiment, the thickness of the one or more support members 216, and the one or more mounting brackets 114 may vary between 2.4 mm and 3.5 mm.

In accordance with the present disclosure, a method of manufacturing the reflector assembly 210, 310, 410 for the base station antenna is disclosed. The method comprises providing the reflector 214, 314, 414 configured for mounting the plurality of radiating elements 300, 400 thereon. In an embodiment, the reflector 214, 314, 414 may be composed of an aluminum alloy coated mild steel. The aluminum alloy coated mild steel may be formed by coating a steel base with an aluminum alloy alloy by a hot dipping process. Further, the method may comprise bending the lateral sides of the reflector 214, 314, 414 to form a U-shaped profile 212, 312, 412, when viewed from a side of the reflector 214, 314, 414. Also, the method may comprise at least one of grinding or buffing the reflector 214, 314, 414 to achieve a surface finish of the reflector 214, 314, 414, before bending the lateral sides of the reflector 214, 314, 414.

The following tests were employed to validate the performance of an aluminum silicon coated mild steel reflector, in respect of results anticipated to cause performance variations due to its ferro-magnetic properties:

| Test Type | Construction & Environment | Anticipated Result | Measured Result |
|---|---|---|---|
| Return Loss | An antenna having an aluminum | >14 dB (4% reflection, | >14 dB (4% reflection, 96% |
| (RL) Test | silicon coated mild steel was tested | 96% power into the | power into the antenna) for all |
| | in an Industry Standard RL | antenna) for all bands | bands used in CommScope |
| | measurement chamber | used | |
| Passive | The antenna having an aluminum | >−150 dbC for all ports | >−150 dbC for all ports |
| Intermodulation | silicon coated mild steel was tested | | |
| Test (PIM) | in an Industry Standard PIM | | |
| | chamber | | |
| Far Field | Pattern data was measured for the | No change in Azimuth | No change in Azimuth & |
| Pattern Test | antenna having an aluminum | & Elevation patterns | Elevation patterns from the |
| | silicon coated mild steel and | from the base model | base model |
| | compared to a benchmark | | |
| Salt-Fog Test | Temperature: +35° C. ± 2° C., | Return Loss > 14 dB | Return Loss > 14 dB |
| | Spray Distribution: 1.0-2.0 | PIM > −150 dB C | PIM > −150 dB C |
| | mL/80 cm2 receptacle, | | |
| | Solution pH density: 6.5~7.2 5% | | |
| | NaCl, Test duration: 30 days | | |

The table below further provides a comparative analysis of characteristics of a reflector made of aluminum (i.e., a conventional reflector) vis-à-vis a reflector made from aluminum silicon coated mild steel (i.e., the reflector of an embodiment of the present invention):

| | | | Antenna with | | Antenna with |
|---|---|---|---|---|---|
| | | Antenna with | aluminum silicon | Antenna with | aluminum silicon |
| | | aluminum | coated mild steel | aluminum | coated mild steel |
| Electrical Specifications | Unit | reflector | reflector | reflector | reflector |
| Frequency Range | MHz | 694-960 | | 1695-2690 | |
| NON-BASTA GAIN | dBi | 15.71 | 15.67 | 16.78 | 16.93 |
| (mean) | | | | | |
| BASTA Gain, dBi (mean) | dBi | 15.43 | 15.43 | 16.27 | 16.42 |
| Gain Tolerance, (±1.5 | dB | 0.45 | 0.44 | 0.68 | 0.71 |
| STDV) | | | | | |
| Horizontal Beamwidth @ | Deg | 70.03 | 70.60 | 61.88 | 62.23 |
| 3 dB points, deg (mean) | | | | | |
| Beamwidth Tolerance, | Deg | 2.03 | 1.90 | 5.55 | 6.33 |
| Horizontal, (Tolerance) | | | | | |
| Cross Polarity Ratio @ | dB | 23.00 | 25.70 | 17.88 | 19.95 |
| Boresight, dB (typical) | | | | | |
| Front to back ratio (Co- | dB | 26.23 | 28.17 | 28.55 | 28.68 |
| pol) at 180° ± 30°, dB | | | | | |
| (typical) | | | | | |
| Vertical beamwidth | Deg | 9.80 | 9.90 | 7.55 | 7.48 |
| [degrees]/b = mean ± tolerance; | | | | | |
| 1st (USLS), dB (typical; | dB | 17.13 | 17.13 | 17.20 | 18.10 |
| w/c) | | | | | |

The reflectors 214, 314, 414 made from an aluminum alloy coated mild steel have high heat resistance and high heat reflectivity. Also, the reflectors 214, 314, 414 have high resistant to corrosion and have improved salt spray life.

The various embodiments of the present disclosure have been described above with reference to the accompanying drawings. The present disclosure is not limited to the illustrated embodiments; rather, these embodiments are intended to fully and completely disclose the subject matter of the disclosure to those skilled in this art. In the drawings, like numbers refer to like elements throughout. Thicknesses and dimensions of some components may be exaggerated for clarity.

Herein, the terms “attached”, “connected”, “interconnected”, “contacting”, “mounted”, “coupled” and the like can mean either direct or indirect attachment or contact between elements, unless stated otherwise.

Well-known functions or constructions may not be described in detail for brevity and/or clarity. As used herein the expression “and/or” includes any and all combinations of one or more of the associated listed items.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises”, “comprising”, “includes” and/or “including” when used in this specification, specify the presence of stated features, operations, elements, and/or components, but do not preclude the presence or addition of one or more other features, operations, elements, components, and/or groups thereof.

While considerable emphasis has been placed herein on the particular features of this disclosure, it will be appreciated that various modifications can be made, and that many changes can be made in the preferred embodiments without departing from the principles of the disclosure. These and other modifications in the nature of the disclosure or the preferred embodiments will be apparent to those skilled in the art from the disclosure herein, whereby it is to be distinctly understood that the foregoing descriptive matter is to be interpreted merely as illustrative of the disclosure and not as a limitation.

| ELEMENT | REFERRAL NUMERAL |
|---|---|
| Reflector assembly of prior art | 10 |
| Front of the reflector | 12 |
| Back of the reflector | 14 |
| First and second sides of the reflector | 16 |
| Main reflective surface | 20 |
| Plurality of openings | 22 |
| Base station antenna of present disclosure | 100 |
| Radome | 110 |
| Mounting brackets | 114 |
| Top end cap | 115A |
| Bottom end cap | 115B |
| Connectors | 117 |
| Reflector Assembly | 210 |
| U-shaped profile | 212 |
| Reflector | 214 |
| Support members | 216 |
| Low band radiating elements | 300 |
| Reflector Assembly | 310 |
| U-shaped profile | 312 |
| Reflector | 314 |
| High band radiating elements | 400 |
| Reflector Assembly | 410 |
| U-shaped profile | 412 |
| Reflector | 414 |

The embodiments herein and the various features and advantageous details thereof are explained with reference to the non-limiting embodiments in the description. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the embodiments as described herein.

Any discussion of documents, acts, materials, devices, articles and the like that has been included in this specification is solely for the purpose of providing a context for the disclosure. It is not to be taken as an admission that any or all of these matters form a part of the prior art base or were common general knowledge in the field relevant to the disclosure as it existed anywhere before the priority date of this application.

The numerical values mentioned for the various physical parameters, dimensions or quantities are only approximations and it is envisaged that the values higher/lower than the numerical values assigned to the parameters, dimensions or quantities fall within the scope of the disclosure, unless there is a statement in the specification specific to the contrary.

That which is claimed is:

1. A reflector assembly for a base station antenna, the reflector assembly configured to be disposed within a radome of the base station antenna, the reflector assembly comprising:
a reflector configured to mount a plurality of radiating elements thereon,
wherein the reflector is composed of an aluminum alloy coated mild steel.

2. The reflector assembly as claimed in claim 1, wherein the reflector comprises lateral sides extending along a longitudinal axis of the reflector, and each lateral side is bent to form a U-shaped profile.

3. The reflector assembly as claimed in claim 2, wherein a free end of the U-shaped profile of each lateral side is bent outwardly away from the reflector.

4. The reflector assembly as claimed in claim 2, wherein a free end of the U-shaped profile of each lateral side is bent inwardly towards the reflector.

5. The reflector assembly as claimed in claim 4, wherein the reflector comprises two portions arranged at an angle with respect to each other to form an inverted V-shape, and each of the two portions is inclined at an angle of around 25-33° from a plane containing a line of contact of the two portions.

6. The reflector assembly as claimed in claim 1, comprising:
one or more support members and one or more mounting brackets that are adapted to provide support and facilitate mounting of the reflector in the radome,
wherein the one or more support members and the one or more mounting brackets are composed of an aluminum alloy coated mild steel.

7. The reflector assembly as claimed in claim 1, wherein the aluminum alloy coated mild steel comprises a steel base coated with either an aluminum silicon alloy or an aluminum zinc alloy by a hot dipping process.

8. The reflector assembly as claimed in claim 1, wherein the reflector comprises a steel substrate having an electromagnetic reflective surface made of an aluminum alloy coating.

9. A base station antenna, comprising:
a radome;
a top end cap and a bottom end cap to cover openings of the radome; and
a reflector assembly configured to be disposed within the radome, the reflector assembly comprising:
a reflector configured to mount a plurality of radiating elements thereon,
wherein the reflector of the reflector assembly is composed of an aluminum alloy coated mild steel.

10. The base station antenna as claimed in claim 9, wherein the reflector comprises lateral sides extending along a longitudinal axis of the reflector, and each lateral side is bent to form a U-shaped profile, when viewed from a side of the reflector.

11. The base station antenna as claimed in claim 10, wherein a free end of the U-shaped profile of each lateral side is bent outwardly away from the reflector.

12. The base station antenna as claimed in claim 10, wherein a free end of the U-shaped profile of each lateral side is bent inwardly towards the reflector.

13. The base station antenna as claimed in claim 12, wherein the reflector comprises two portions arranged at an angle with respect to each other to form an inverted V-shape, and each of the two portions is inclined at an angle of around 25-33° from a plane containing a line of contact of the two portions.

14. The base station antenna as claimed in claim 9, comprising:
one or more support members and one or more mounting brackets that are adapted to provide support and facilitate mounting of the reflector in the radome,
wherein the one or more support members and the one or more mounting brackets are composed of an aluminum alloy coated mild steel.

15. The base station antenna as claimed in claim 9, wherein the aluminum alloy coated mild steel comprises a steel base coated with an aluminum silicon alloy or an aluminum zinc coating by a hot dipping process.

16. The base station antenna as claimed in claim 9, wherein the reflector comprises a steel substrate having an electromagnetic reflective surface made of an aluminum alloy coating.

17. A method of manufacturing a reflector assembly for a base station antenna, the reflector assembly configured to be disposed within a radome of the base station antenna, the method comprising:
providing a reflector configured for mounting a plurality of radiating elements thereon, wherein the reflector of the reflector assembly is composed of an aluminum alloy coated mild steel formed by coating a steel base with an aluminum alloy by a hot dipping process.

18. The method as claimed in claim 17, comprising:
bending lateral sides of the reflector to form a U-shaped profile, when viewed from a side of the reflector, the lateral sides of the reflector extending along a longitudinal axis of the reflector.

19. The method as claimed in claim 17, comprising:
at least one of grinding or buffing the reflector to achieve a surface finish of the reflector.

20. The method as claimed in claim 19, wherein the aluminium alloy coated mild steel is either aluminium silicon coated mild steel or aluminium zinc coated mild steel.
